(19) United States
(12) Patent Application Publication
(10) Pub. No.: US 2024/0063443 A1
(43) Pub. Date: Feb. 22, 2024

(54) Battery Pack for Vehicle

(71) Applicants: Hyundai Motor Company, Seoul (KR); Kia Corporation, Seoul (KR); Valeo Kapec Co., Ltd., Daegu (KR)

(72) Inventors: Hyunchang Kang, Seoul (KR); Jun Young Lim, Seoul (KR); Seoha Kang, Hanam-si (KR); Jun Seok Choi, Hwaseong-si (KR); Kyubin Chung, Seoul (KR); Ji Woong Han, Daegu (KR); Wan Choi, Daegu (KR); Houk Park, Daegu (KR); Jae Eun Kim, Daegu (KR)

(21) Appl. No.: 18/318,127

(22) Filed: May 16, 2023

(30) Foreign Application Priority Data
Aug. 16, 2022 (KR) 10-2022-0102142

(51) Int. Cl. H01M 10/42; H01M 50/502; B60R 16/02; H01M 50/211; H01M 10/48; H01M 50/262; H01M 10/6554; H01M 10/625

(52) U.S. Cl. CPC H01M 10/425; H01M 50/502; B60R 16/0207; H01M 50/211; H01M 10/486; H01M 10/482; H01M 50/262; H01M 10/6554; H01M 10/625; H01M 2220/20

(57) ABSTRACT

An embodiment battery module includes a plurality of battery cells provided as a pouch type, a plurality of cartridges, each of the cartridges holding the battery cells that are adjacent to each other and form a pair, a sensing block coupled to a lateral side of the plurality of cartridges to bind the plurality of cartridges to each other, the sensing block including a first connector configured to electrically connect the plurality of battery cells and a second connector configured to measure voltage of the plurality of battery cells, and a lateral cover coupled to an outward side of the sensing block to bind the sensing block and the plurality of cartridges to each other, the lateral cover including a first opening that exposes the first connector to an outside and a second opening that exposes the second connector to the outside.

### CROSS-REFERENCE TO RELATED APPLICATIONS

This application claims the benefit of Korean Patent Application No. 10-2022-0102142, filed on Aug. 16, 2022, which application is hereby incorporated herein by reference.

### TECHNICAL FIELD

The disclosure relates to a battery pack for a vehicle.

### BACKGROUND

Generally, a vehicle includes a battery pack with a plurality of batteries. With the recent increasing demand for a vehicle using an electric motor, such as a hybrid electric vehicle, a fuel cell vehicle, an electric vehicle, and an eco-friendly vehicle, demand for the battery pack is also increasing.

In particular, customers' needs for the electric vehicle are diversifying, such as a long travel distance with a single charge, short acceleration time (0 to 60 mph), and short charging time to a full charge. Accordingly, it is required to improve technology such as high capacity and high output of a battery system, and it is essential to increase the energy density of the battery system. As major technical methods, there is a method of increasing the capacity of the battery pack in which battery modules or battery cells are loaded. However, such a method causes an increase in the weight of the vehicle and an increase in the cost of production.

Usually, the battery pack includes a plurality of battery modules and other parts for connecting the battery modules. Conventionally, the battery module includes an end plate for supporting stacked battery cells forward and backward in a stacking direction, and a base plate for supporting the stacked battery cells downward, and a coupling groove provided in the base plate is coupled to a protrusion of the end plate, thereby supporting the battery pack.

Due to the plurality of battery modules increased in capacity for loading the battery cells therein, and other parts, the cost of production increases and the manufacturing process becomes complicated. To cope with the increasing cost of production and the complicated manufacturing process, it is required to simplify a manufacturing process for assemblies, in particular, an assembly process in order to reduce the cost, decrease the weight, and increase manufacturing efficiency.

### SUMMARY

The disclosure relates to a battery pack for a vehicle. Particular embodiments relate to a battery pack assembly structure in which a process for manufacturing a battery module is simplified to improve a manufacturing efficiency.

An embodiment of the disclosure provides a battery module assembly for a vehicle, in which an assembly method of simplifying fastening between parts is employed in a battery module for the vehicle.

An embodiment of the disclosure provides a battery module assembly for a vehicle, in which the number of different parts is reduced in a battery module for the vehicle.

An embodiment of the disclosure provides a battery module assembly fora vehicle, of which the structure is simplified in the battery module of the vehicle.

An embodiment of the disclosure provides a battery pack structure for a vehicle, in which an assembly method of simplifying fastening between a battery module and lower, upper, and lateral plates and covers is employed in a battery pack for the vehicle.

An embodiment of the disclosure provides a battery pack structure for a vehicle, in which the number of different parts is reduced in a battery pack for the vehicle.

An embodiment of the disclosure provides a battery pack structure for a vehicle, of which the structure is simplified in a battery pack for the vehicle.

An embodiment of the disclosure provides a battery pack structure for a vehicle, of which the weight is decreased in a battery pack for the vehicle.

An embodiment of the disclosure provides a battery pack structure for a vehicle, in which heat generated in a battery module is dissipated in a battery pack for the vehicle.

Additional embodiments of the disclosure will be set forth in part in the description which follows and, in part, will be obvious from the description, or may be learned by practice of the disclosure.

In accordance with an embodiment, there is provided a battery module including a plurality of battery cells provided as a pouch type, a cartridge holding the battery cells which are adjacent to each other and form a pair, the cartridge provided in plurality, a sensing block coupled to a lateral side of the plurality of cartridges to bind the plurality of cartridges to each other, and including a first connector to electrically connect the plurality of battery cells and a second connector to measure voltage of the plurality of battery cells, and a lateral cover coupled to an outward side of the sensing block to bind the sensing block and the cartridges to each other, and including a first opening to expose the first connector to the outside and a second opening to expose the second connector to the outside.

The battery module may further include a first fastener provided in each of first and second portions of each cartridge to fasten the adjacent cartridges to each other, in which the first fastener includes a first protrusion protruding from the cartridge, and a first groove recessed to insert therein the first protrusion formed in the adjacent cartridge.

The battery module may further include a second fastener to fasten the cartridge and the sensing block to each other, in which the second fastener includes a second protrusion protruding from an inward side of the sensing block and a second groove formed in the lateral side of the cartridge and recessed to couple with the second protrusion.

The battery module may further include a third fastener to fasten the cartridge and the sensing block to each other, in which the third fastener includes a third protrusion provided on an inward side of the sensing block and including a hook, and a third groove provided in the lateral side of the cartridge and coupling with the third protrusion.

The battery module may further include a fourth fastener to fasten the lateral cover and the sensing block to each other, in which the fourth fastener includes a fourth protrusion provided on the outer side of the sensing block and including a hook, and a fourth groove provided on an inward side of the lateral cover and coupling with the hook of the fourth protrusion.

The battery module may further include a guide to guide the second protrusion to be inserted in the second groove along the same axial direction, in which the guide includes a guide protrusion provided on the sensing block and a guiding groove provided in the lateral side of the cartridge and inserting the guiding protrusion therein.

In accordance with an embodiment, there is provided a battery pack including a battery module stacking body including a plurality of battery modules stacked in a thickness direction of a pouch-type battery cell so that each battery module can hold a plurality of pouch-type battery cells, each battery module including a plurality of battery cells provided as a pouch type, a cartridge holding the battery cells which are adjacent to each other and form a pair, the cartridge including a plurality of cartridges, a sensing block coupled to a lateral side of the plurality of cartridges to bind the plurality of cartridges to each other, and including a first connector to electrically connect the plurality of battery cells and a second connector to measure voltage of the plurality of battery cells, and a lateral cover coupled to an outward side of the sensing block to bind the sensing block and the cartridges to each other, and including a first opening to expose the first connector to the outside and a second opening to expose the second connector to the outside, a lower plate extended along a stacking direction of the battery module stacking body and positioned beneath the battery module stacking body, an upper plate extended along the stacking direction of the battery module stacking body and positioned on the battery module stacking body, a pair of end plates disposed at front and rear sides in the stacking direction of the battery module stacking body and fastened to the lower plate and the upper plate, respectively, to support the battery module stacking body, and an upper cover covering an upper portion of the battery module and fastened to the upper plate.

The battery pack may further include a fifth fastener to fasten the battery module and the lower plate to each other, in which the fifth fastener includes a fifth protrusion provided in a lower end of the cartridge and a guide support bar provided in the lower plate and accommodating the fifth protrusion therein.

The battery pack may further include a sixth fastener to fasten the upper cover and the upper plate to each other, in which the sixth fastener includes a sixth protrusion provided on the upper plate and a fifth groove provided in the upper cover and coupling with the sixth protrusion.

The battery pack may further include a seventh fastener to fasten the end plates, the upper plate, and the lower plate to one another, in which the seventh fastener includes a seventh protrusion provided at the lateral side of the lower plate, an eighth protrusion provided at the lateral side of the upper plate, and sixth grooves provided in the end plates and coupling with the seventh protrusion and the eighth protrusion.

The battery pack may further include an eighth fastener to fasten the end plate and the upper cover to each other, in which the eighth fastener includes a ninth protrusion provided in an outward side of the end plate and facing upward and a seventh groove formed penetrating the upper cover and coupling with the ninth protrusion.

The battery pack may further include a bus bar assembly to electrically connect the battery modules of the battery module stacking body, in which the bus bar assembly includes a bus bar coupled to the first connector and a bus bar cover accommodating the bus bar therein.

The battery pack may further include a ninth fastener to fasten the bus bar and the bus bar cover to each other, in which the ninth fastener includes a tenth protrusion provided in an inward side of the bus bar cover and including a hook and an eighth groove provided in the bus bar and coupling with the tenth protrusion.

The battery pack may further include a tenth fastener to fasten the sensing block and the bus bar cover, in which the tenth fastener includes an eleventh protrusion provided in an outward side of the sensing block and including a hook and a ninth groove provided in the inward side of the bus bar cover and coupling with the eleventh protrusion.

The battery pack may further include a wire harness connected to the second connector to transmit an electrical signal and current.

The battery pack may further include a binder to bind the wire harness, the end plate, and the lower plate to one another, in which the binder includes one or more third openings formed as holes through the end plate and the lower plate and one or more binding devices coupling with the third openings and binding the wire harness.

The lower plate may include a plate-shaped pair of support bars to support the battery module.

The cartridge may include one or more first channels on an upper portion and a lower portion corresponding to the upper portion to dissipate heat of the battery module.

The battery pack may be mounted to a base plate through the lower plate, one of the pair of end plates may include a lower surface protruding to come into close contact with the base plate, and the other one of the pair of end plates may include a lower surface being spaced apart from the base plate and forming a second channel between the lower surface and the base plate.

The upper cover may include one or more third channels to dissipate heat of the battery pack.

The battery pack may further include a temperature sensor to measure an internal temperature of the battery pack, in which the temperature sensor includes a measurer coupled to the inside of the cartridge and a wire transmitting measurement information of the measurer to the outside.

The end plate may include a band cable at the outside thereof to couple with the wire.

The lower plate may include one or more insert pins to be fastened to the base plate and insert bushes corresponding to the insert pins.

The upper cover may include one or more brackets to be fastened to an upper portion of the upper cover.

The lateral cover includes wing plates provided at opposite sides thereof to hold outermost cartridges among the cartridges and partially covering the outermost cartridges.

The battery pack may further include a polycarbonate film provided at front and rear sides of the battery module to protect outermost battery cells of the battery module and keep an insulation distance.

The cartridge may include first double-sided tapes at front and rear sides thereof, to which the battery cells are attached.

The polycarbonate film may include a second double-sided tape attachable to the outermost battery cell of the battery module.

The first fastener may be formed at one or more positions in upper and lower portions of the cartridge.

The second fastener may be formed at one or more positions in upper and lower portions of the sensing block and the cartridge.

The third fastener may be formed at one or more positions in upper and lower portions of the sensing block and the cartridge.

The fourth fastener may be formed at one or more positions in upper and lower portions of the sensing block and the lateral cover.

The guide may be formed at one or more positions in upper and lower portions of the sensing block and the cartridge.

The lower plate may include a first ethylene propylene member in a portion being in contact with the battery module.

The upper plate may include a second ethylene propylene member in a portion being in contact with the battery module.

The upper cover may include a third ethylene propylene member in a third channel and a portion being in contact with the battery module and the temperature sensor.

The end plates may further include the ninth protrusion not to couple with the seventh groove.

### BRIEF DESCRIPTION OF THE DRAWINGS

Embodiments of the disclosure will be described in detail with reference to the accompanying drawings, but the technical idea of the disclosure should not be construed as being limited only to the accompanying drawings because such drawings show preferred embodiments.

These and/or other features of embodiments of the disclosure will become apparent and more readily appreciated from the following description of the embodiments, taken in conjunction with the accompanying drawings, in which:

FIG. 1 is a perspective view showing an assembled state of a battery module for a vehicle according to an embodiment;

FIG. 2 is a perspective view showing a single cartridge in a battery module for a vehicle according to an embodiment;

FIG. 3 is a perspective view showing the back of a sensing module in a battery module for a vehicle according to an embodiment;

FIG. 4 shows a perspective view of a lateral cover in a battery module for a vehicle according to an embodiment and an enlarged view of a part A including a fourth protrusion in the lateral cover;

FIG. 5 shows a perspective view of an assembled battery pack for a vehicle according to an embodiment and an enlarged view of a part D including a wire provided in a temperature sensor and a wire provided in an end plate;

FIG. 6 is a perspective view showing a state in which a battery module, a lower plate, an upper plate, and a polycarbonate film are assembled in a battery pack for a vehicle according to an embodiment;

FIG. 7 is a perspective view showing a state in which a lower plate is not assembled in a battery pack for a vehicle according to an embodiment;

FIG. 8 is an enlarged view showing a state in which a lower plate and a battery module are bound in a battery pack for a vehicle according to an embodiment;

FIG. 9 is a perspective view showing a state in which an upper plate is not assembled in a battery pack for a vehicle according to an embodiment;

FIG. 10 is a front view of an upper cover viewed from below in a battery pack for a vehicle according to an embodiment;

FIG. 11 is a perspective view showing an end plate with second channel holes between a pair of end plates in a battery pack for a vehicle according to an embodiment;

FIG. 12 is a perspective view showing an end plate with no second channel holes between a pair of end plates in a battery pack for a vehicle according to an embodiment;

FIG. 13 shows a perspective view of a bus bar assembly including a bus bar and a bus bar cover accommodating the bus bar, and an enlarged view of a ninth fastener included in the bus bar cover in a battery pack for a vehicle according to an embodiment;

FIG. 14 is a perspective view showing a bus bar accommodated in a bus bar cover in a battery pack for a vehicle according to an embodiment;

FIG. 15 is an enlarged view showing a ninth groove of a tenth fastener included in the inside of a bus bar cover in a battery pack for a vehicle according to an embodiment;

FIG. 16 is an enlarged view showing an eleventh protrusion of a tenth fastener included in the outside of a sensing block in a battery module for a vehicle according to an embodiment; and

FIG. 17 is an enlarged view showing a binder including a binding device and a third opening of a lower plate in a battery pack for a vehicle according to an embodiment.

### DETAILED DESCRIPTION OF ILLUSTRATIVE EMBODIMENTS

Hereinafter, embodiments of the disclosure will be described in detail with reference to the accompanying drawings. The embodiments are provided in order to fully explain the spirit and scope of the disclosure to those skilled in the aft. Thus, the disclosure is not to be construed as limited to the embodiments set forth herein and may be accomplished in other various embodiments. Parts irrelevant to the description are omitted in the drawings in order to clearly explain embodiments of the present disclosure. Sizes of elements in the drawings may be exaggerated in order to facilitate understanding.

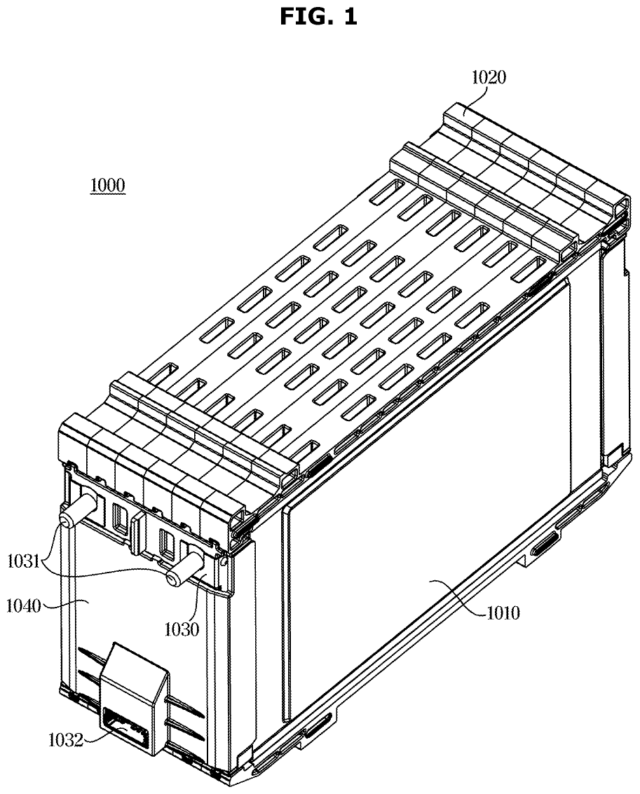

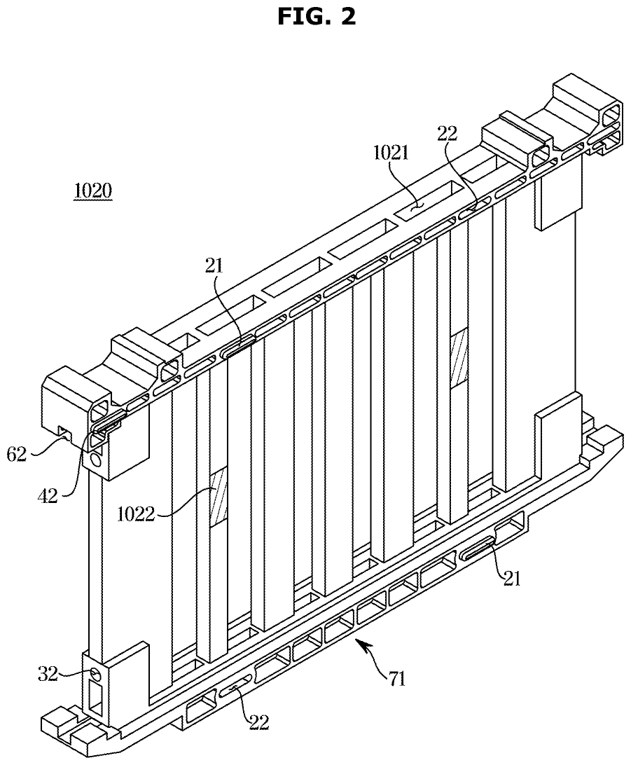

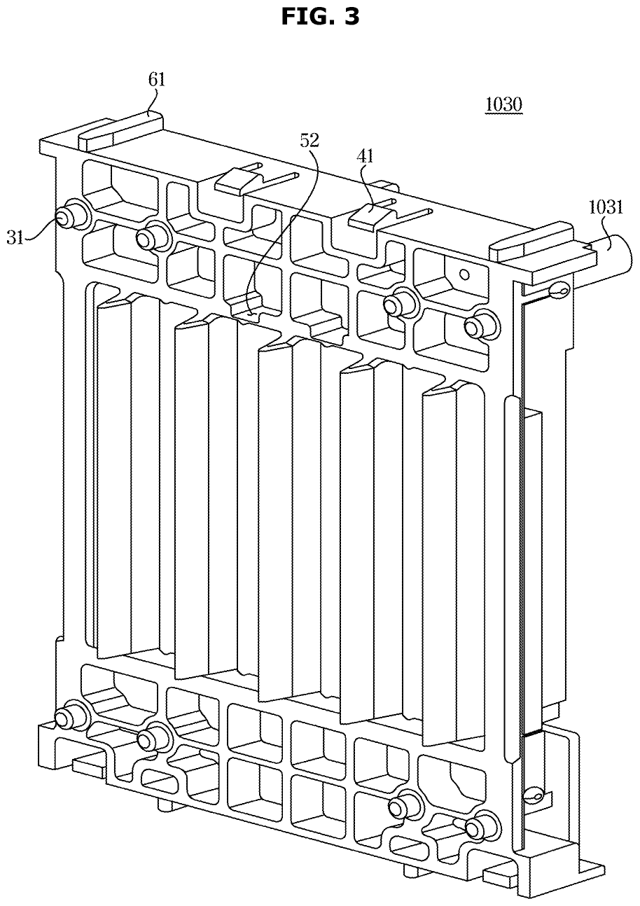

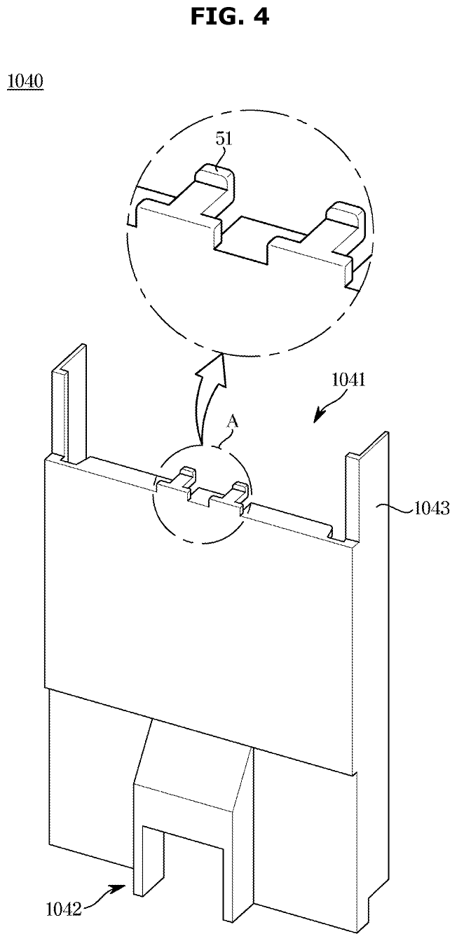

FIG. 1 is a perspective view showing an assembled state of a battery module woo for a vehicle according to an embodiment, FIG. 2 shows a single cartridge 1020, FIG. 3 shows the back of a sensing module, and FIG. 4 is a perspective view of a lateral cover 1040. Below, with reference to FIGS. 1 to 4, the structures, purposes, and effects of elements will be described, the configurations for coupling the elements will be described, and a coupling sequence then will be described.

Referring to FIGS. 1 to 4, the battery module woo for the vehicle according to an embodiment of the disclosure includes a battery cell low, the cartridge 1020, a sensing block 1030, and the lateral cover 1040, and includes first to fourth fasteners and a guide to couple such elements.

The battery module moo refers to a battery assembly in which a predetermined number of battery cells 1010 each provided in the form of a pouch are grouped and put into a frame to be protected from an external impact, heat, vibration, etc.

The battery cell low provided in the form of the pouch is a basic unit of a lithium-ion battery usable for charging and discharging electric energy. The battery cell low is manufactured with an anode, a cathode, a separator, and an electrolyte which are put into a rectangular aluminum casing. The battery provided in the vehicle includes a plurality of battery cells low.

The cartridge 1020 holds a pair of battery cells low adjacent to each other. The cartridge 1020 includes first double-sided tapes 1022 at front and rear sides thereof, to which the battery cells 1010 are attachable, and is thus capable of holding the battery cell 1010. There are provided a plurality of cartridges 1020 to hold a plurality of battery cells 1010. Because the battery cells 1010 are attached one by one to the front and rear sides of the cartridges 1020, N−1 cartridges 1020 are needed to stack N battery cells 1010. The plurality of cartridges 1020 increases efficiency at manufacturing the battery module moo because they are uniformly structured and employ the double-sided tapes to which the battery cells 1010 are easily attachable. Further, the cartridge 1020 is formed with one or more first channels 1021 on the top and bottom thereof, thereby dissipating heat generated in the battery module moo and preparing a space to accommodate other elements such as a temperature sensor 1800.

The sensing block 1030 is coupled to the lateral side of the plurality of cartridges 1020 and binds the plurality of cartridges 1020 to each other. The sensing block 1030 includes a first connector 1031 for electrically connecting the plurality of battery cells 1010 and a second connector 1032 for measuring voltage of the plurality of battery cells 1010. Through the sensing block 1030, the stacked cartridges 1020 and the stacked battery cells 1010 are not only physically protectable from the outside, but are also electrically connectable to the outside.

The lateral cover 1040 is coupled to the outer side of the sensing block 1030 and binds the sensing block 1030 and the cartridge 1020 to each other. The lateral cover 1040 includes a first opening 1041 through which the first connector 1031 is exposed to the outside and a second opening 1042 through which the second connector 1032 is exposed to the outside. Therefore, the lateral cover 1040 physically protects the stacked cartridges 1020 and the stacked battery cells 1010 as well as the sensing block 1030 from the outside. Further, the lateral cover 1040 may include wing plates 1043 capable of partially covering the outermost cartridges 1020 at opposite sides to hold the outermost cartridges 1020 among the cartridges 1020. Therefore, the lateral cover 1040 binds the cartridge 1020 and a sensor module in a direction where the cartridges 1020 are stacked.

The first fastener includes a first protrusion 21 protruding from the cartridge 1020, and a first groove 22 recessed to insert therein the first protrusion 21 formed in the adjacent cartridge 1020. Further, the first fastener may be formed at one or more positions in the upper and lower portions of the cartridge 1020. Through the first fastener, the plurality of cartridges 1020 having the same structure are coupled not to move in height and lengthwise directions without any separate element for the coupling, thereby increasing the manufacturing efficiency.

The second fastener includes a second protrusion 31 protruding from the inside of the sensing block 1030 to fasten the cartridge 1020 and the sensing block 1030 to each other and a second groove 32 recessed in the lateral side of the cartridge 1020 and coupling with the second protrusion 31. Further, the second fastener may be formed at one or more positions in the upper and lower portions of the sensing block 1030 and the cartridge 1020. Through the second fastener, the plurality of cartridges 1020 having the same structure are coupled to the sensing block 1030 without any separate element and are prevented from moving in their stacking direction.

The third fastener includes a third protrusion 41 provided in the inward side of the sensing block 1030 and having a hook to fasten the cartridge 1020 and the sensing block 1030 to each other, and a third groove 42 provided in the lateral side of the cartridge 1020 and coupling with the hook of the third protrusion 41. Further, the third fastener may be formed at one or more positions in the upper and lower portions of the sensing block 1030 and the cartridge 1020. Such a fastening structure based on the groove and the hook coupling with the groove without any separate coupling element is called a snap-fit structure. Through the third fastener, the plurality of cartridges 1020 having the same structure are coupled to the sensing block 1030 without any separate element and are prevented from moving in their stacking direction.

The fourth fastener includes a fourth protrusion 51 provided outside the lateral cover 1040 and having a hook to fasten the lateral cover 1040 and the sensing block 1030 to each other, and a fourth groove 52 provided in the inward side of the sensing block 1030 and coupling with the hook of the fourth protrusion 51. Further, the fourth fastener may be formed at one or more positions in the upper and lower portions of the sensing block 1030 and the lateral cover 1040. Through such a snap-fit structure, the lateral cover 1040 and the sensing block 1030 are coupled without any separate element.

The guide includes a guiding protrusion 61 provided on the sensing block 1030 and a guiding groove 62 provided on the lateral side of the cartridge 1020 and inserting the guiding protrusion 61 therein. Further, the guide may be formed at one or more positions of the upper and lower portions of the sensing block 1030 and the cartridge 1020. Through the guide, the sensing block 1030 and the cartridge 1020 are easily coupled without any separate element, and the plurality of cartridges 1020 are prevented from moving in their stacking direction.

An assembly method or sequence for the battery module woo will be described below. The battery cells are attached to the first double-sided tapes 1022 provided in the front and rear sides of a single cartridge 1020. Then, the cartridge 1020 attached with the battery cells, which includes a unit, is provided in plurality, and the plurality of cartridges 1020 are stacked by the first fastener.

Then, the sensing block 1030 is coupled to the lateral side of the plurality of stacked cartridges 1020 by the second to third fasteners and the guide. Then, the lateral cover 1040 is coupled to the sensing block 1030 by the fourth fastener.

The battery module woo for the vehicle according to an embodiment includes the battery cell low, the cartridge 1020, the lateral cover 1040, and the sensing block 1030. Referring to FIG. 1, the battery module woo includes a total of six cartridges 1020 and a total of seven battery cells low. Referring to FIG. 2, the single cartridge 1020 includes a total of six first channels 1021 on the top thereof, and includes a total of seven pillars for supporting the upper and lower portions. Among the pillars, two pillars are provided with the first double-sided tapes 1022 so that the battery cells low can be attached to the front and rear sides of the cartridge 1020. The cartridge 1020 includes a total of two first protrusions 21 and multiple first grooves 22 in the upper portion thereof, and includes one first protrusion 21 and one first groove 22 in the lower portion. Thus, the adjacent cartridges 1020 are coupled so that the plurality of cartridges 1020 can be stacked.

Referring to FIGS. 2 and 3, the cartridge 1020 and the sensing block 1030 are coupled by the second to third fasteners and the guide. The cartridge 1020 is provided with the guiding groove 62, the second groove 32, and the third groove 42 at the lateral side of the upper and lower portions thereof. The sensing block 1030 includes the guiding protrusions 61 formed at first and second portions and two third protrusions 41 formed in a middle portion on the top thereof, and includes two second protrusions 31 formed at each of the first and second portions on each of inward upper and lower sides thereof. Therefore, the guide is coupled to two opposite cartridges 1020 among the total of six stacked cartridges 1020, and the second fastener is coupled to four opposite cartridges 1020.

Referring to FIGS. 3 and 4, the sensing block 1030 and the lateral cover 1040 are coupled by the fourth fastener. The lateral cover 1040 includes a total of two fourth protrusions 51 formed in a middle portion on an upper end surface thereof and coupled to the fourth grooves 52 positioned in a middle portion of the sensing block 1030. The lateral cover 1040 includes the wing plates 1043 protruding upward from opposite lateral sides thereof, and the first opening 1041 formed between the wing plates 1043 and allowing the two first connectors 1031 provided in an upper front side of the sensing block 1030 to be exposed. The lateral cover 1040 includes the second opening 1042 formed in a lower portion thereof and allowing the second connector 1032 provided in a middle portion to be exposed. However, the positions, shapes, and number of first to fourth fasteners and guides are not limited to those shown in FIGS. 1 to 4, but include any structure for coupling two elements.

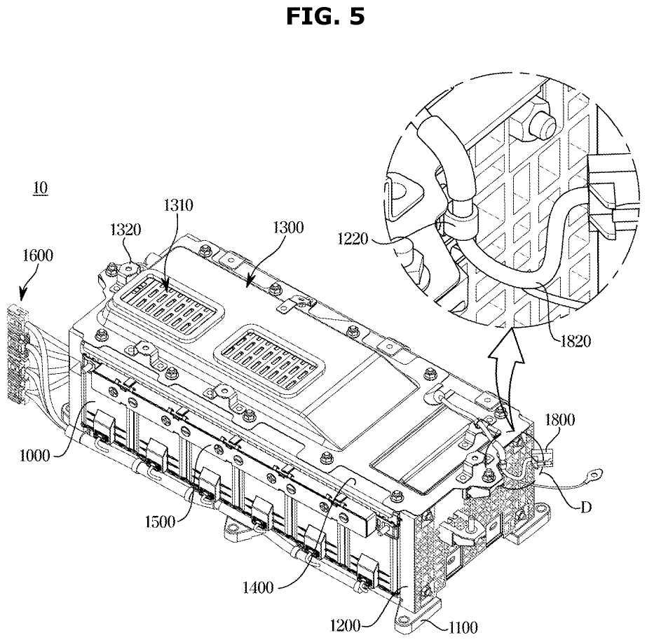

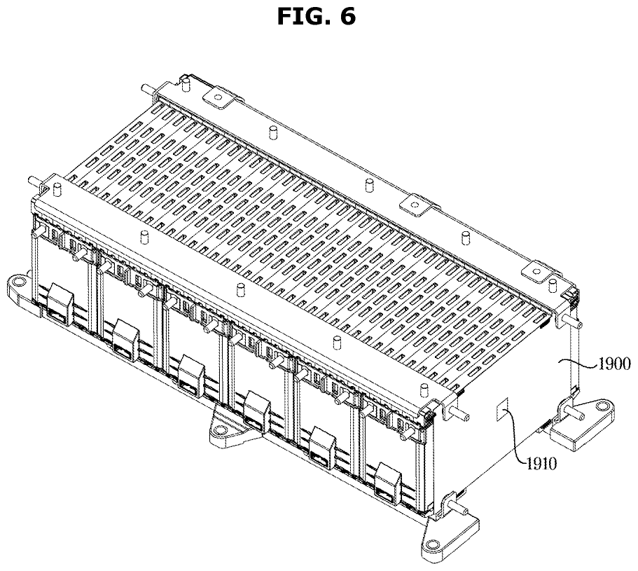

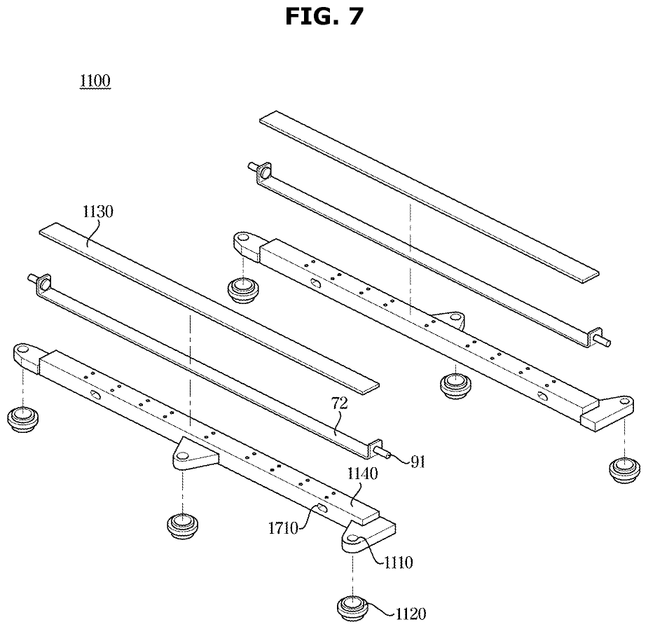

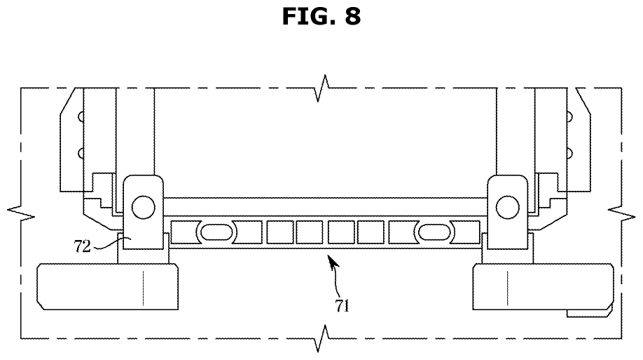

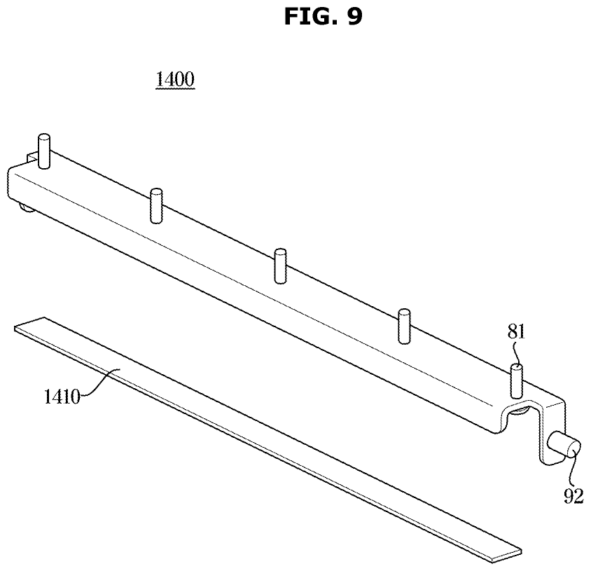

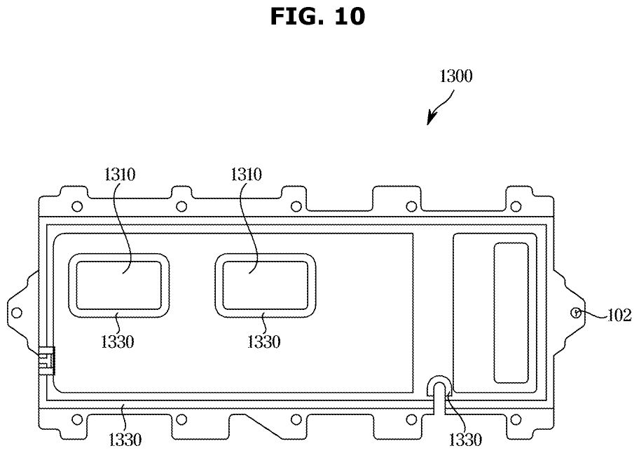

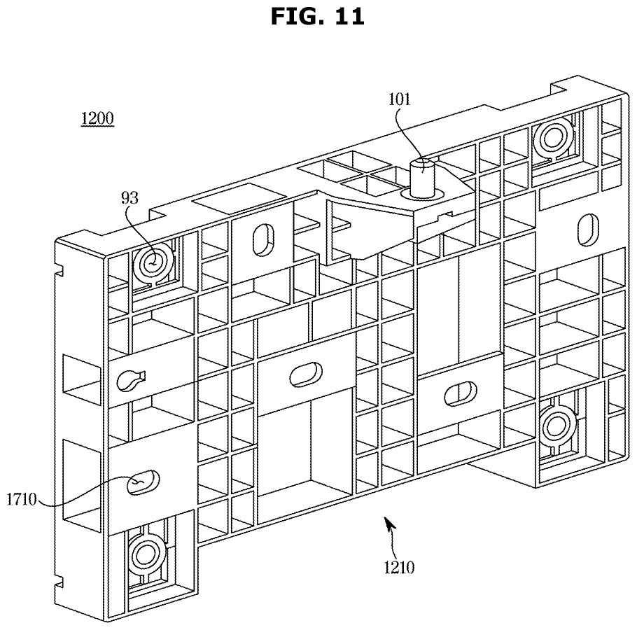

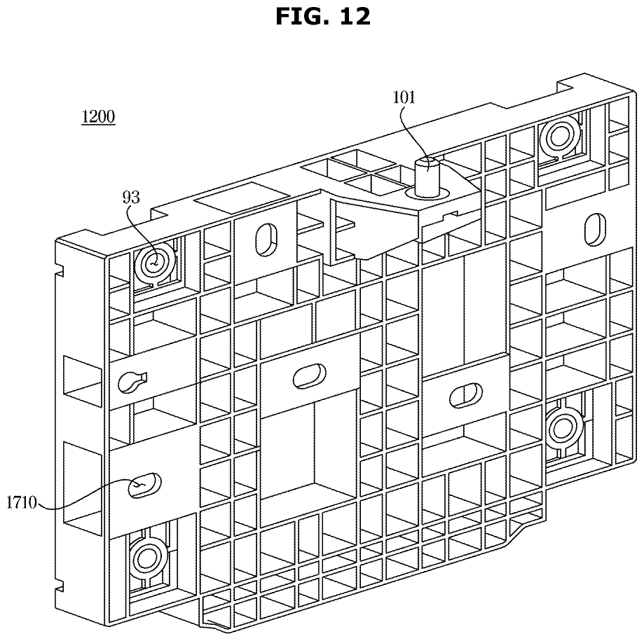

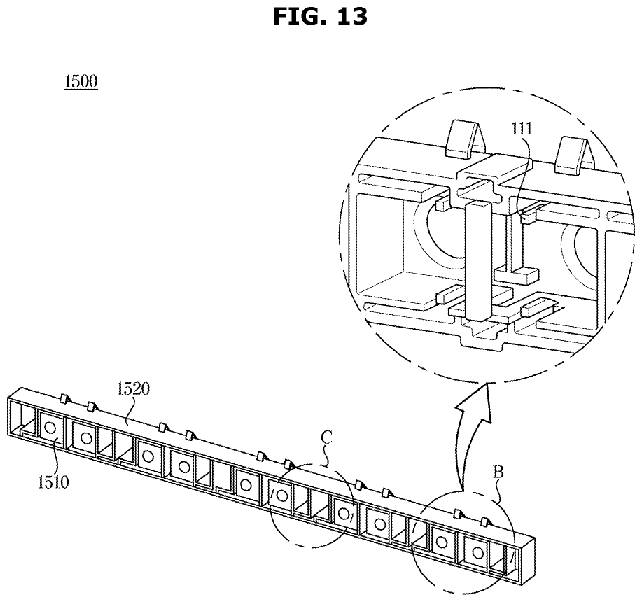

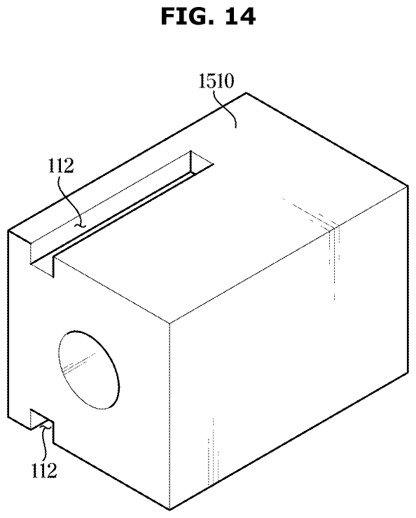

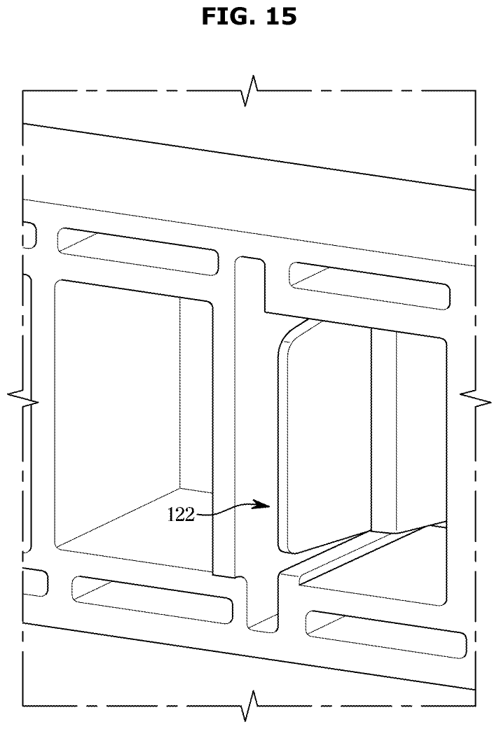

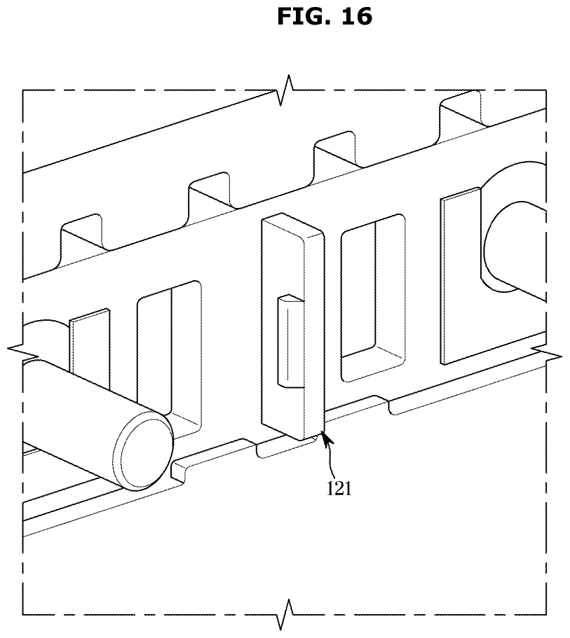

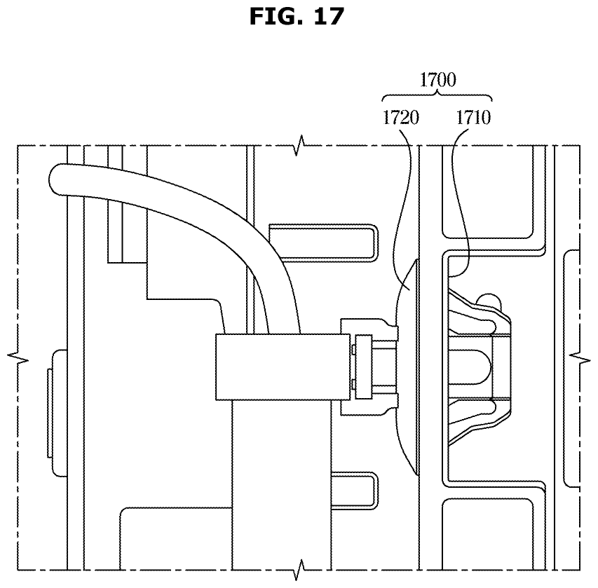

FIG. 5 shows a perspective view of an assembled battery pack 10 for a vehicle according to an embodiment and an enlarged view of a part D including a wire provided in a temperature sensor and a wire provided in an end plate, FIG. 6 is a perspective view showing a state in which a battery module moo, a lower plate 1100, an upper plate 1400, and a polycarbonate film 1900 are assembled in the battery pack 10, FIG. 7 is a perspective view showing a state in which the lower plate 1100 is not assembled, FIG. 8 is an enlarged view showing a state in which the lower plate 1100 and the battery module woo are bound, FIG. 9 shows an upper plate 1400, FIG. 10 is a front view of an upper cover, FIGS. 11 and 12 are perspective views of a pair of end plates 1200, FIG. 13 shows a perspective view of a bus bar assembly 1500 including a bus bar 1510 and a bus bar cover accommodating the bus bar 1510 and an enlarged view of a ninth fastener included in the bus bar cover, FIG. 14 is a perspective view showing the bus bar accommodated in the bus bar cover in a battery pack for a vehicle according to an embodiment, FIG. 15 is an enlarged view showing a ninth groove 122 of a tenth fastener included in the inside of the bus bar cover, FIG. 16 is an enlarged view showing an eleventh protrusion 121 of the tenth fastener included in the outside of a sensing block 1030, and FIG. 17 is an enlarged view showing a binder 1700 including a binding device 1720 and a third opening 1710 of the lower plate 1100 in the battery pack 10 for a vehicle according to an embodiment. Below, with reference to FIGS. 5 to 17, the structures, purposes, and effects of elements will be described, the configurations for coupling the elements will be described, and a coupling sequence then will be described.

Referring to FIGS. 5 to 17, the battery pack 10 for a vehicle according to an embodiment of the disclosure includes the battery module moo, the lower plate 1100, the upper plate 1400, the upper cover, and the end plate 1200, and further includes the bus bar assembly 1500, a wire harness 1600, a temperature sensor 1800, and the polycarbonate film 1900. To couple the elements, fifth to tenth fasteners and the binder 1700 are further provided.

The battery pack 10 refers to a final form of a battery system mounted to an electric vehicle, which is completed by mounting various control and protection systems such as a battery management system (BMS) and a cooling system to the battery module woo and generally includes a plurality of battery modules 1000. Specifically, the plurality of battery modules moo are stacked in a thickness direction of the pouch-type battery cells 1010 to form a battery module stacking body, and thus other elements are coupled thereto.

The lower plate 1100 is extended along the stacking direction of the battery module stacking body and positioned beneath the battery module stacking body. The lower plate 1100 may include a support bar 1140, an insert pin 1110, an insert bush 1120, and an ethylene propylene member. Specifically, the support bar 1140 may be provided as a pair of plates to support the battery module 1000. Because the support bar 1140 is provided as not a single wide plate but a pair of plates having a small width, it is possible to reduce cost and weight. One or more insert pins 1110 may be provided to be fastened to a base plate (not shown) under the lower plate 1100, and the insert bush 1120 may be provided corresponding to the insert pin 1110. In this case, the base plate (not shown) refers to an element to which the battery pack 10 is finally mounted. In other words, the insert pin 1110 of the lower plate 1100 penetrates the base plate (not shown) from top to bottom while passing through a hole formed in the base plate (not shown), and the insert bush 1120 couples with the penetrated lower end of the insert pin 1110 so that the battery pack 10 can be mounted to the base plate (not shown). A first ethylene propylene member 1130 may be provided in a portion where the lower plate 1100 is in contact with the battery module 1000. The ethylene propylene member is made of a copolymer of ethylene and propylene monomers and has ozone resistance, weather resistance, chemical resistance, and electrical insulating properties. The first ethylene propylene member 1130 is provided in a contact portion between the lower plate 1100 and the battery module moo and allows the lower plate 1100 and the battery module moo to couple with each other in an airtight manner.

An upper cover 1300 refers to a cover for covering an upper portion of the battery module woo and is fastened to the upper plate 1400. The upper cover 1300 may be manufactured by a press. The upper cover 1300 includes one or more third channels 1310 to dissipate heat from the battery pack 10. Further, the upper cover 1300 includes one or more brackets 1320 to be fastened to the upper portion of the upper plate 1400. The brackets 1320 may be welded to the upper cover 1300 and may be used in coupling with a high voltage (HV) cover. The upper cover 1300 includes a third ethylene propylene member 1330 in a portion to be in contact with the battery module moo and the temperature sensor 1800 and in the third channel 1310. In this case, the third ethylene propylene member 1330 may include low foaming ethylene propylene for airtight coupling in a portion to be in contact with the upper cover 1300 and high foaming ethylene propylene for airtight coupling and impact noise prevention in the third channel 1310.

The upper plate 1400 is extended along the stacking direction of the battery module stacking body and positioned on the battery module stacking body. The upper plate 1400 may be formed with an end portion bent inward to hold the battery pack 10 not to move in the lengthwise direction. The upper plate 1400 may include a second ethylene propylene member 1410 in a portion to be in contact with the battery module 1000. Through the second ethylene propylene member 1410, it is possible to couple two elements in an airtight manner.

The end plates 1200 are provided as a pair, disposed at front and rear sides in the stacking direction of the battery module stacking body, and respectively fastened to the lower plate 1100 and the upper plate 1400, thereby supporting the battery module stacking body. One of the pair of end plates 1200 includes a lower surface protruding to come into close contact with the base plate (not shown), and the other one is formed with a second channel 1210 in a lower portion to dissipate heat from the battery pack 10. Specifically, when the battery pack 10 is coupled to the base plate (not shown), the end plate 1200 having no second channel 1210 is coupled matching the shape of the base plate (not shown), and the end plate 1200 having the second channel 1210 is coupled being spaced apart from the base plate (not shown). Therefore, cool air introduced into the third channel 1310 of the upper cover flows under each cartridge through the first channels 1021 formed in the upper and lower portions of the cartridge, and such flowing cool air is then discharged through the second channel 1210. To this end, an air suction device (not shown) is provided at the second channel 1210, and the suction force of the air suction device (not shown) causes air to flow from the third channel 1310 to the second channel 1210. The end plate 1200 may, as shown in FIG. 5, include a band cable 1220 at the outside thereof to couple with a wire 1820 provided in the temperature sensor 1800.

The bus bar assembly 1500 is configured to electrically connect the battery modules woo and includes a bus bar 1510 coupled to the first connector 1031 and a bus bar cover 1520 accommodating the bus bar 1510 therein. The bus bar assembly 1500 electrically connects the plurality of battery modules woo through the first connector 1031 on the lateral side of the battery pack 10, and the bus bar cover 1520 includes one or more fuses in a middle thereof. Therefore, the first connectors 1031 of the battery pack 10 except the rightmost and leftmost first connectors 1031 may be connected through the bus bar assembly 1500, and the rightmost and leftmost first connectors 1031 may be connected through a separate high-voltage cable cover and supply voltage. The bus bar assembly may be hinged on the sensing block 1030 to implement an openable structure for checking a state after the coupling.

The wire harness 1600 is connected to the second connector 1032 to transmit an electric signal and current. In this case, the wire harness 1600 refers to a total wiring set through which the electric signal and current generated in parts of the vehicle and electronic products are transmitted between the parts so that each system can play its own role. The wire harness 1600 may include the wire harness 1600 for measuring voltage.

The temperature sensor 1800 may include a measurer coupled to the inside of the cartridge 1020 and measuring the internal temperature of the battery pack 10 and the wire 1820 transmitting measurement information of the measurer to the outside. In this case, the measurer may have a clip shape for coupling.

The polycarbonate film 1900 is provided in the front and rear of the battery module woo to protect the outermost battery cell 1010 of the battery module woo and keep an insulation distance. In this case, the polycarbonate film 1900, the material of which is one of thermoplastic resins, is easy to process, lightweight, and excellent in electrical insulation and heat resistance. The polycarbonate film 1900 includes a second double-sided tape 1910 attachable to the outermost battery cell 1010 of the battery module 1000. Therefore, the polycarbonate film 1900 may be coupled to the battery module woo without any separate element.

The fifth fastener includes a fifth protrusion 71 provided in a lower end of the cartridge 1020 and fastening the battery module moo and the lower plate 1100 to each other and a guide support bar 72 provided in the lower plate 1100 and accommodating the fifth protrusion 71 therein. Through the fifth fastener, the battery module moo is guided and seated on the lower plate 1100 so that the battery module moo and the lower plate 1100 can be coupled to each other without any separate element.

The sixth fastener includes a sixth protrusion 81 provided on the upper plate 1400 and fastening the upper cover 1300 and the upper plate 1400 to each other and a fifth groove 82 provided in the upper cover 1300 and coupling with the sixth protrusion 81. Through the sixth fastener, the upper cover 1300 and the upper plate 1400 are coupled without any separate element.

The seventh fastener includes a seventh protrusion 91 provided at the lateral side of the lower plate 1100 and an eighth protrusion 92 provided at the lateral side of the upper plate 1400 so as to fasten the end plates 1200, the upper plate 1400, and the lower plate 1100 to each other, and sixth grooves 93 provided in the end plates 1200 and coupling with the seventh protrusion 91 and the eighth protrusion 92. According to an embodiment, one or more of the seventh protrusion 91 and the eighth protrusion 92 may be formed as a screw. In this case, the upper and lower plates 1400 and 1100 may be fastened to the end plates 1200 by bolt-screw coupling with the end plates 1200 therebetween.

The eighth fastener includes a ninth protrusion 101 provided in the outward side of the end plate 1200 and facing upward to fasten the end plate 1200 and the upper cover 1300 to each other, and a seventh groove 102 formed penetrating the upper cover 1300 and coupling with the ninth protrusion 101. Through the eighth fastener, the end plate 1200 and the upper cover 1300 are coupled without any separate element.

The ninth fastener includes a tenth protrusion 111 provided in the inward side of the bus bar cover 1520 and having a hook to fasten the bus bar 1510 and the bus bar cover 1520 to each other, and an eighth groove 112 provided in the bus bar 1510 and coupling with the tenth protrusion 111. Through the ninth fastener, the bus bar 1510 and the bus bar cover 1520 are coupled by the snap-fit structure without any separate element.

The tenth fastener includes an eleventh protrusion 121 provided in the outward side of the sensing block 1030 and having a hook to fasten the sensing block 1030 and the bus bar cover 1520 to each other, and a ninth groove 122 provided in the inward side of the bus bar cover 1520 and coupling with the eleventh protrusion 121. Through the tenth fastener, the sensing block 1030 and the bus bar cover 1520 are coupled by the snap-fit structure without any separate element.

The binder 1700 includes one or more third openings 1710 formed as holes through the end plate 1200 and the lower plate 1100 to bind the wire harness 1600, the end plate 1200, and the lower plate 1100 to each other, and one or more binding devices 1720 coupling with the third openings 1710 and binding the wire harness 1600.

An assembly method or sequence for the battery pack 10 will be described below. The completely assembled battery module woo is coupled to one pair of lower plates 1100 through the fifth fastener. Then, the polycarbonate film 1900 is attached to the outermost battery cell 1010 of the battery module moo through the second double-sided tape. Then, the upper plate 1400 is coupled to the upper end of the battery module 1000. Then, one pair of end plates are coupled to the front and rear of the battery module woo through the eighth fastener. Then, the temperature sensor 1800 is coupled such that the measurer of the temperature sensor 1800 is coupled to the inside of the cartridge 1020 and the wire is coupled to the end plate 1200 through the band cable 1220. Then, the upper cover is coupled to the end plate 1200 through the eighth fastener. Then, the bus bar assembly 1500 is coupled to the sensing block 1030 through the tenth fastener of the bus bar cover 1520. Then, the wire harness 1600 is coupled to the end plate 1200 and the lower plate 1100 through the binder 1700.

The battery pack 10 for a vehicle according to an embodiment includes the battery module 1000, the lower plate 1100, the upper plate 1400, the end plate 1200, the upper cover, the bus bar assembly 1500, the temperature sensor 1800, and the wire harness 1600. Referring to FIGS. 5 to 6, the schematic arrangement of the elements is illustrated. Referring to FIG. 7, one pair of lower plates 1100 each includes the support bar 1140, the guide support bar 72, and the first ethylene propylene member 1130. The support bar 1140 is provided with a total of three insert pins 1110 in front, rear, and lateral sides thereof to fasten the battery pack 10 to the base plate, and the insert bushes 1120 are provided corresponding to the insert pins 1110. Referring to FIG. 8, the cartridge 1020 and the lower plate 1100 of the battery module woo may be coupled through the fifth fastener, and the fifth protrusion provided in the lower end of the cartridge 1020 is coupled to and supported by one pair of lower plates 1100. Referring to FIG. 9, the upper plate 1400 is shaped like a plate and includes a total of five sixth protrusions 81 protruding upward and the eighth protrusion 92 protruding laterally. Bolts are welded to the sixth protrusions, and the second ethylene propylene member 1410 is provided beneath the upper plate 1400.

Referring to FIG. 6, the polycarbonate film 1900 is attached to the lower plate 1100 and the upper plate 1400 at the lateral side of the battery pack 10 by the second double-sided tape 1910. Referring to FIGS. 7 and 9 to 12, the end plate 1200 is coupled to the battery pack 10 through the eighth fastener. FIGS. 11 and 12 are different in the presence or absence of the second channel 1210 in one pair of end plates 1200. Besides, the sixth grooves 93 coupling with the seventh protrusion 91 and the eighth protrusion 92 of the eighth fastener are provided at four vertex positions on the inward side of the end plate 1200, and a plurality of third openings 1710 are formed penetrating the inward side of the end plate 1200. Here, it is possible to reach the plurality of third openings 1710 from above or below or laterally. Referring to FIG. 12, the bus bar cover 1520 is formed with compartments in which the bus bars 1510 are accommodated and between which a fuse is formed. According to an alternative embodiment, a rectangular bus bar cover 1520 may be provided with no fuses. The bus bar cover 1520 is formed with hinges on the top thereof to couple with the sensing block 1030. Referring to the enlarged view of the part B, i.e., the inside of the bus bar cover 1520 in FIG. 13, the bus bar 1510 is coupled to the bus bar cover 1520 through the ninth fastener including a total of four tenth protrusions 111, i.e., two tenth protrusions 111 on each of upper and lower sides.

Referring to FIGS. 15 and 16, the bus bar assembly 1500 is coupled to the sensing block 1030 through the tenth fastener. The ninth groove 122 is provided so that the eleventh protrusion 121 can be inserted in a portion where the fuse is formed in the bus bar cover 1520. Referring to FIGS. 7, 11, 12, and 17, the binder 1700 may bind the wire harness 1600 to the lower plate 1100 and the end plate 1200. Thus, the lower plate 1100 is formed with the third opening 1710 in a lateral direction, the end plate 1200 is formed with the third opening 1710 in an outward direction, and the binding device 1720 is coupled to the third opening 1710, so that the body of the binding device 1720 can be fastened to the third opening 1710 and a binding arm can hold the wire harness 1600. However, the positions, shapes, and number of fifth to tenth fasteners and the binder 1700 are not limited to those shown in FIGS. 5 to 17, but include any structure for coupling two elements.

With this configuration, the battery modules woo of the battery pack 10 for a vehicle according to an embodiment transmit the voltage of the battery cell 1010 to the outside through the cartridge 1020, the sensing block 1030, and the lateral cover 1040 of the battery module woo and at the same time are bound to one battery module woo. Further, the elements are easily assembled through the first to fourth fasteners and the guide without any separate element, thereby decreasing the number of different parts for the battery module moo, simplifying the structure, and simplifying the assembly method.

Further, the elements are easily assembled and bound without any separate element through the fifth to tenth fasteners and the binder 1700 for binding the lower plate 1100, the upper plate 1400, the bus bar assembly 1500, the wire harness 1600, the temperature sensor 1800, and the polycarbonate film 1900 of the battery pack 10 for a vehicle according to an embodiment, thereby decreasing the number of different parts for the battery module moo, simplifying the structure, and simplifying the assembly method.

Further, in the battery pack 10 for a vehicle according to an embodiment, heat generated inside the battery pack 10 is dissipated through the first to third channels 1310, airtight coupling between the elements is possible through the first to third ethylene propylene members 1330, and coupling between the elements is simplified through the first and second double-sided tapes 1910. Therefore, the battery pack 10 becomes lightweight, is decreased in cost of production, and is thus improved in merchantable quality.

According to an embodiment, there is provided a battery module for a vehicle, in which an assembly method of simplifying fastening between pails is employed.

According to an embodiment, there is provided a battery module for a vehicle, in which the number of different parts is reduced.

According to an embodiment, there is provided a battery module for a vehicle, of which the structure is simplified.

According to an embodiment, there is provided a battery pack for a vehicle, in which an assembly method of simplifying fastening between a battery module and lower, upper, and lateral plates and covers is employed.

According to an embodiment, there is provided a battery pack structure for a vehicle, in which the number of different parts is reduced in a battery pack for the vehicle.

According to an embodiment, there is provided a battery pack for a vehicle, of which the structure is simplified.

According to an embodiment, there is provided a battery pack for a vehicle, of which the weight is decreased.

According to an embodiment, there is provided a battery pack for a vehicle, in which heat generated in a battery module is dissipated.

As described above, although the disclosure has been shown and described with respect to a few specific embodiments and drawings, those skilled in the art should appreciate that various modifications and changes may be made in the technical concept of the disclosure, the scope of which is defined in the claims and their equivalents.

What is claimed is:

1. A battery module comprising:
a plurality of battery cells provided as a pouch type;
a plurality of cartridges, each of the cartridges holding an adjacent pair of the battery cells;
a sensing block coupled to a lateral side of the plurality of cartridges to bind the plurality of cartridges to each other, the sensing block comprising a first connector to electrically connect the plurality of battery cells and a second connector to measure voltage of the plurality of battery cells; and
a lateral cover coupled to an outward side of the sensing block to bind the sensing block and the cartridges to each other, the lateral cover comprising a first opening to expose the first connector to an outside and a second opening to expose the second connector to the outside.

2. The battery module of claim 1, further comprising first fasteners provided in each of first and second portions of each of the plurality of cartridges to fasten adjacent cartridges of the plurality of cartridges to each other, wherein the first fasteners comprise:
first protrusions protruding from the plurality of cartridges; and
first grooves recessed to receive the first protrusions of the adjacent cartridge.

3. The battery module of claim 2, wherein each of the cartridges comprises first channels on an upper portion and a lower portion corresponding to the upper portion to dissipate heat of the battery module.

4. The battery module of claim 2, wherein each of the cartridges comprises first double-sided tapes at front and rear sides thereof to which the battery cells are attached.

5. The battery module of claim 2, wherein the first fasteners are provided at one or more positions in upper and lower portions of the plurality of cartridges.

6. The battery module of claim 1, further comprising a second fastener configured to fasten the plurality of cartridges and the sensing block to each other, wherein the second fastener comprises:
a second protrusion protruding from an inward side of the sensing block; and
a second groove provided in the lateral side of the plurality of cartridges and recessed to couple with the second protrusion.

7. The battery module of claim 6, wherein the second fastener is provided at one or more positions in upper and lower portions of the sensing block and the plurality of cartridges.

8. The battery module of claim 6, further comprising a guide configured to guide the second protrusion to be inserted in the second groove along a same axial direction, wherein the guide comprises:
a guide protrusion provided on the sensing block; and
a guiding groove provided in the lateral side of the plurality of cartridges and receiving the guiding protrusion therein.

9. The battery module of claim 8, wherein the guide is provided at one or more positions in upper and lower portions of the sensing block and the plurality of cartridges.

10. The battery module of claim 1, further comprising a third fastener configured to fasten the plurality of cartridges and the sensing block to each other, wherein the third fastener comprises:
a third protrusion provided on an inward side of the sensing block, the third protrusion comprising a hook; and
a third groove provided in the lateral side of the plurality of cartridges and coupling with the third protrusion.

11. The battery module of claim 10, wherein the third fastener is provided at one or more positions in upper and lower portions of the sensing block and the plurality of cartridges.

12. The battery module of claim 1, further comprising a fourth fastener configured to fasten the lateral cover and the sensing block to each other, wherein the fourth fastener comprises:
a fourth protrusion provided on an outer side of the sensing block, the fourth protrusion comprising a hook; and
a fourth groove provided on an inward side of the lateral cover and coupling with the hook of the fourth protrusion.

13. The battery module of claim 12, wherein the fourth fastener is provided at one or more positions in upper and lower portions of the sensing block and the lateral cover.

14. The battery module of claim 1, wherein the lateral cover comprises wing plates provided at opposite sides thereof to hold outermost cartridges among the plurality of cartridges and to partially cover the outermost cartridges.

15. A battery pack comprising:
a battery module stacking body comprising a plurality of battery modules stacked in a thickness direction of a pouch-type battery cell;
a lower plate extended along a stacking direction of the battery module stacking body and positioned beneath the battery module stacking body;
an upper plate extended along the stacking direction of the battery module stacking body and positioned on the battery module stacking body;
a pair of end plates disposed at front and rear sides in the stacking direction of the battery module stacking body and fastened to the lower plate and the upper plate, respectively, to support the battery module stacking body; and
an upper cover covering an upper portion of the battery module and fastened to the upper plate;
wherein each of the plurality of battery modules comprises:
a plurality of battery cells provided as a pouch type;
a plurality of cartridges, each cartridge holding an adjacent pair of the battery cells;
a sensing block coupled to a lateral side of the plurality of cartridges to bind the plurality of cartridges to each other, wherein the sensing block comprises a first connector to electrically connect the plurality of battery cells and a second connector to measure voltage of the plurality of battery cells; and
a lateral cover coupled to an outward side of the sensing block to bind the sensing block and the plurality of cartridges to each other, wherein the lateral cover comprises a first opening to expose the first connector to an outside and a second opening to expose the second connector to the outside.

16. The battery pack of claim 15, further comprising a fifth fastener configured to fasten the plurality of battery modules and the lower plate to each other, wherein the fifth fastener comprises:
a fifth protrusion provided in a lower end of the plurality of cartridges; and
a guide support bar provided in the lower plate and accommodating the fifth protrusion therein.

17. The battery pack of claim 15, further comprising a sixth fastener configured to fasten the upper cover and the upper plate to each other, wherein the sixth fastener comprises:
a sixth protrusion provided on the upper plate; and
a fifth groove provided in the upper cover and coupling with the sixth protrusion.

18. The battery pack of claim 15, further comprising a seventh fastener configured to fasten the pair of end plates, the upper plate, and the lower plate to one another, wherein the seventh fastener comprises:
a seventh protrusion provided at a lateral side of the lower plate;
an eighth protrusion provided at a lateral side of the upper plate; and
sixth grooves provided in the pair of end plates and coupling with the seventh protrusion and the eighth protrusion.

19. The battery pack of claim 15, further comprising an eighth fastener configured to fasten the pair of end plates and the upper cover to each other, wherein the eighth fastener comprises:
a ninth protrusion provided in an outward side of the pair of end plates and facing upward; and
a seventh groove formed penetrating the upper cover and coupling with the ninth protrusion.

20. The battery pack of claim 19, wherein the pair of end plates may further comprise the ninth protrusion not to couple with the seventh groove.

21. The battery pack of claim 15, further comprising a bus bar assembly configured to electrically connect the battery modules of the battery module stacking body, wherein the bus bar assembly comprises:
a bus bar coupled to the first connector; and
a bus bar cover accommodating the bus bar therein.

22. The battery pack of claim 21, further comprising a ninth fastener configured to fasten the bus bar and the bus bar cover to each other, wherein the ninth fastener comprises:
a tenth protrusion provided in an inward side of the bus bar cover, wherein the tenth protrusion comprises a hook; and
an eighth groove provided in the bus bar and coupling with the tenth protrusion.

23. The battery pack of claim 21, further comprising a tenth fastener configured to fasten the sensing block and the bus bar cover, wherein the tenth fastener comprises:
an eleventh protrusion provided in the outward side of the sensing block, wherein the eleventh protrusion comprises a hook; and
a ninth groove provided in an inward side of the bus bar cover and coupling with the eleventh protrusion.

24. The battery pack of claim 15, further comprising a wire harness connected to the second connector and configured to transmit an electric signal and current.

25. The battery pack of claim 24, further comprising a binder configured to bind the wire harness, the pair of end plates, and the lower plate to one another, wherein the binder comprises:
one or more third openings provided as holes through the pair of end plates and the lower plate; and
one or more binding devices coupling with the third openings and binding the wire harness.

26. The battery pack of claim 15, wherein the lower plate comprises a pair of support bars shaped like a plate to support the plurality of battery modules.

27. The battery pack of claim 15, wherein:
the battery pack is mounted to a base plate through the lower plate;
a first end plate of the pair of end plates comprises a first lower surface protruding to come into close contact with the base plate; and
a second end plate of the pair of end plates comprises a second lower surface that is spaced apart from the base plate and defines a second channel between the second lower surface and the base plate.

28. The battery pack of claim 27, wherein the lower plate comprises:
an insert pin configured to be fastened to the base plate; and
an insert bush corresponding to the insert pin.

29. The battery pack of claim 15, wherein the upper cover comprises a third channel configured to dissipate heat of the battery pack.

30. The battery pack of claim 15, further comprising a temperature sensor configured to measure an internal temperature of the battery pack, wherein the temperature sensor comprises:
a measurer coupled to the inside of the plurality of cartridges; and
a wire configured to transmit measurement information of the measurer to the outside.

31. The battery pack of claim 30, wherein the pair of end plates comprises a band cable at an outside thereof to couple with the wire.

32. The battery pack of claim 15, wherein the upper cover comprises a bracket configured to be fastened to an upper portion of the upper cover.

33. The battery pack of claim 15, further comprising a polycarbonate film provided at front and rear sides of the plurality of battery modules, wherein the polycarbonate film is configured to protect an outermost battery cell of the plurality of battery modules and to keep an insulation distance.

34. The battery pack of claim 33, wherein the polycarbonate film comprises a second double-sided tape attachable to the outermost battery cell of the plurality of battery modules.

35. The battery pack of claim 15, wherein:
the lower plate comprises a first ethylene propylene member in a portion that is in contact with the plurality of battery modules;
the upper plate comprises a second ethylene propylene member in a portion that is in contact with the plurality of battery modules; and
the upper cover comprises a third ethylene propylene member in a third channel and in a portion that is in contact with the plurality of battery modules and a temperature sensor.
